(19) United States
(12) Patent Application Publication
(10) Pub. No.: US 2007/0000450 A1
(43) Pub. Date: Jan. 4, 2007

(54) Device for brushing animals

(75) Inventor: Martijn Otten, Rotterdam (NL)

Correspondence Address: HOWREY LLP, C/O IP DOCKETING DEPARTMENT, 2941 FAIRVIEW PARK DR., SUITE 200, FALLS CHURCH, VA, 22042, US

(73) Assignee: Lely Enterprises AG

(21) Appl. No.: 11/475,221

(22) Filed: Jun. 27, 2006

(30) Foreign Application Priority Data
Jun. 29, 2005 (NL) 1029371

(51) Int. Cl. A01K 13/00

(52) U.S. Cl. 119/609

(57) ABSTRACT

A device for brushing animals, provided with a mounting unit (1) for mounting the device to a stationary construction element. A pivot element (2) is connected with the mounting unit (1). A frame (3) is connected with the pivot element (2) in such a way that it is pivotable about said pivot element and comprises a hollow, internal space (4). A brushing unit (5) is fastened on the frame (3), and comprises a driven axis (6), which extends into the space (4). The device is further provided with a driving motor (7) with a drive shaft (8) for driving the brushing unit (5) and a transmission element (9), which is disposed between the drive shaft (8) of the driving motor (7) and the driven axis (6) for transmitting rotation from the drive shaft (8) to the driven axis (6). The transmission element (9) and the driving motor (7) are disposed in the hollow, internal space (4) of the frame (3).

### CROSS REFERENCE TO RELATED APPLICATIONS

This application claims priority from Dutch application number 1029371 filed on 30^{th} Jun. 2005, the contents of which are hereby incorporated by reference in their entirety.

### BACKGROUND OF THE INVENTION

1. Field of the Invention

The invention relates generally to a device for brushing animals, such as cows. In particular, the device relates to motor driven brushes, mounted for pivotal movement.

2. Description of the Related Art

Devices are known for brushing animals in which a mounting unit is provided for mounting the device to a stationary construction element, such as a wall or a beam. A pivot element is connected with the mounting unit and a frame is connected with the pivot element in such a way that it is pivotable about said pivot element. The frame may comprise a hollow, internal space. A brushing unit fastened on the frame comprises a driven axis, which extends into the hollow, internal space of the frame and a driving motor with a drive shaft for driving the brushing unit. In such devices, a transmission element disposed between the drive shaft of the driving motor and the driven axis of the brushing unit for transmitting rotation from the drive shaft to the driven axis, may be disposed at least partially in the hollow, internal space of the frame.

Such a device for brushing animals is known from U.S. Pat. No. 6,318,298 B1. In this known device, the driving motor is fastened near an end of the frame and the brushing unit is fastened near the other end of the frame. The driving motor has a drive shaft, which extends into the hollow space of the frame and which is connected with the driven axis of the brushing unit via a chain. Although this device functions properly, the device nevertheless proves to be subjected to relatively high maintenance costs.

### BRIEF SUMMARY OF THE INVENTION

The present invention addresses these problems at least partially by providing a device for brushing animals which involves relatively low maintenance costs.

For this purpose, a device for brushing animals of the above-described type comprises a mounting unit for mounting the device to a stationary construction element, a pivot element connected with the mounting unit, a frame connected with the pivot element and being pivotable about the pivot element, the frame comprising a hollow internal space, a brushing unit fastened on the frame and comprising a driven axis which extends into the hollow internal space of the frame, a driving motor with a drive shaft for driving the brushing unit, the driving motor being disposed in the hollow internal space of the frame and a transmission element disposed between the drive shaft of the driving motor and the driven axis of the brushing unit for transmitting rotation from the drive shaft to the driven axis. Both the transmission element and the driving motor are disposed in the hollow internal space of the frame. The invention is based on the insight that, owing to the fact that the driving motor of the known device is fastened on the outside of the frame, said driving motor is subjected to all sorts of environmental contamination. In particular in a stable, this contamination can be considerable. It has been found that, as a result, the driving motor of the known device has to be cleaned and/or replaced frequently in order to guarantee a correct functioning of the device for brushing animals. This cleaning and/or replacement is not only time-consuming, but also unnecessarily costly. By disposing, according to the invention, the driving motor in the hollow, internal space of the frame, the driving motor is protected against contamination and, consequently, the maintenance costs are strongly reduced.

A preferred embodiment of the device for brushing animals according to the invention, in which the brushing unit is fastened near an end of the frame, is characterized in that the driving motor is disposed near the same end of the frame in the hollow, internal space. The end of the frame where the brushing unit is fastened always being the lower end of the frame, there is thus realised a low centre of gravity.

One embodiment of a device for brushing animals according to the invention is characterized in that the transmission element has a recess for removably including the driven axis of the brushing unit. In this manner a worn brushing unit can quickly be removed, which strongly reduces the time for replacing a brushing unit. It is pointed out that, in the known device, the driven axis is fastened on the frame via bearing elements, which bearing elements are fastened on the frame by means of bolts; in this case, dismounting and replacement of a brushing unit take relatively much time. The transmission element is preferably a worm wheel transmission. This makes it possible to realise a cheap and reliable, direct drive of the driven axis.

One embodiment of a device for brushing animals according to the invention is characterized in that the frame is provided with ventilation apertures. This makes it possible for the heat developed by the driving motor to leave the hollow, internal space of the frame, so that the driving motor will not break down because of overheating.

For connection with an external supply source, a wall of the frame is provided with a connector element for connecting thereto a feeder cable for connection with the external supply source. The feeder cable preferably comprises two feeder cable portions, which are interconnected by means of a connecting element, which is fastened on the mounting unit. In this manner there is realised a safe and robust fastening of the feeder cable in the device.

In one embodiment of a device for brushing animals according to the invention, the driving motor is electrically connected with the connector element via a line, the line being completely located in the hollow, internal space of the frame. Possible damage caused to the line by external influences is thus prevented.

In a further embodiment of a device for brushing animals according to the invention, the driving motor is suitable for rotating the drive shaft in two opposite directions of rotation, and the device is provided with a switch mechanism for alternately rotating the drive shaft in the opposite directions of rotation. It has been found that, owing to the fact that the driving motor is rotated in two directions, less wear is caused to the driving motor. The reversal of the direction of rotation can take place at fixed (or variable), periodically established points of time, for example controlled by means of a timer circuit, or can take place at each brushing run. It is pointed out here that, as described in the above-mentioned state of the art, a brushing run is activated by activating a switch that is operatively connected with the driving motor to activate the driving motor when pressure is exerted on the brushing unit. It is further pointed out that a driving motor that is suitable for driving in two opposite directions is known per se from EP-B1-0840547.

### BRIEF DESCRIPTION OF THE DRAWINGS

The features and advantages of the invention will now be described by way of example with reference to an exemplary embodiment shown in the drawing of a device for brushing animals, in which:

FIG. 1 is a schematic rear view of a device for brushing animals according to the present invention;

FIG. 2 is a partially cross-sectional, side view of the device for brushing animals shown in FIG. 1, and

FIG. 3 is a schematic perspective view of the device for brushing animals as shown in FIGS. 1 and 2.

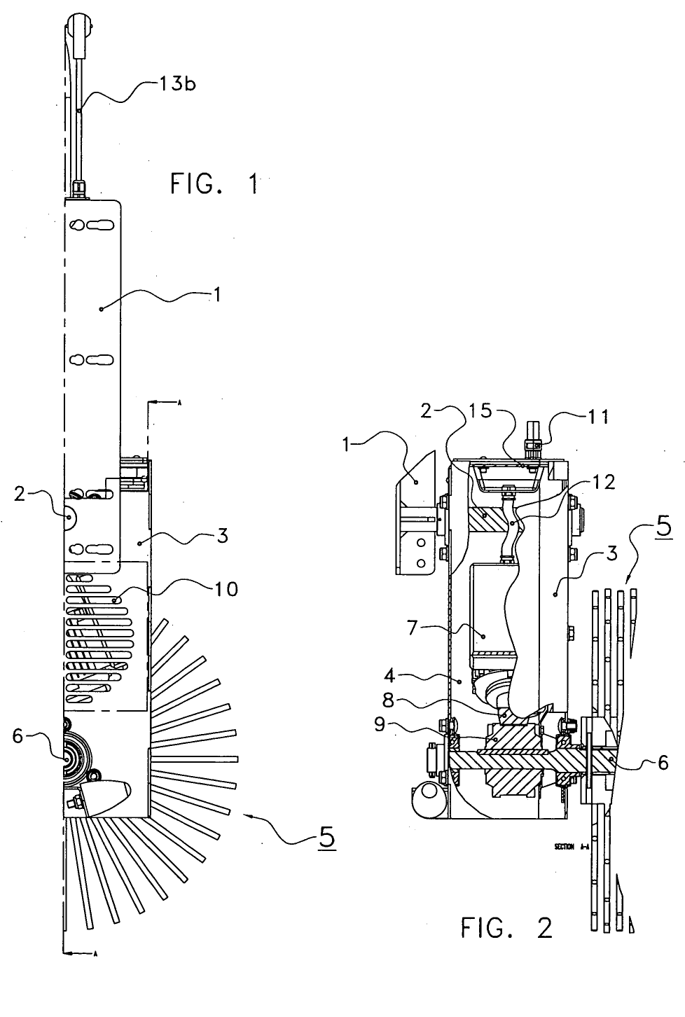

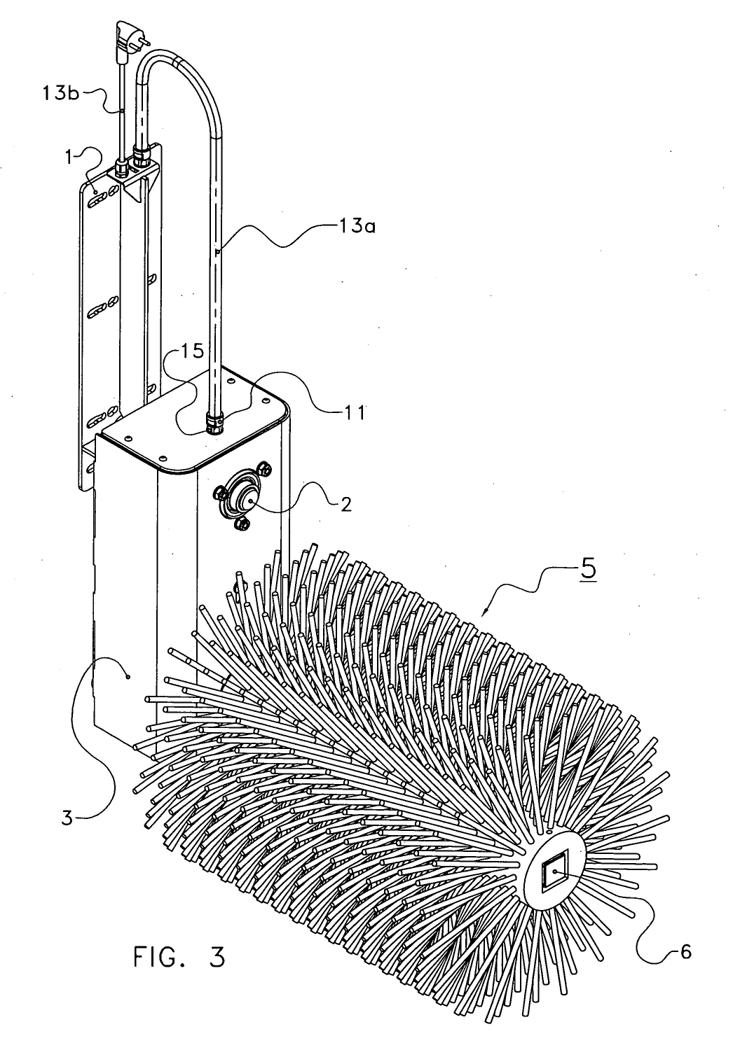

### DESCRIPTION OF ILLUSTRATIVE EMBODIMENTS

FIG. 1 shows a device for brushing animals, such as cows. The device is provided with a mounting unit 1 for mounting the device to a stationary construction element, such as a wall or a beam, of for example a stable. A pivot element 2, for example a rotatable axis, is connected with the mounting unit 1. A frame 3, which is connected with the pivot element 2 in such a way that it is pivotable about said pivot element, comprises a hollow, internal space 4.

A brushing unit 5 is fastened on the frame 3 near an end of said frame 3 and comprises a driven axis 6, which extends into the hollow, internal space 4 of the frame 3. It is pointed out here that by brushing unit is not only meant a unit provided with brush hairs, but also a unit provided with a roll with projections, a unit provided with a roll with sponge-like material, and the like.

A driving motor 7 with a drive shaft 8 for driving the brushing unit 5 is disposed in the hollow, internal space 4 of the frame 3, preferably near the same end of the frame 3 where the brushing unit 5 is disposed.

A transmission element 9, preferably a worm wheel transmission, is disposed between the drive shaft 8 of the driving motor 7 and the driven axis 6 of the brushing unit 5 for transmitting rotation from the drive shaft 8 to the driven axis 6. The transmission element 9 is disposed in the hollow, internal space 4 of the frame 3. It will be obvious that, instead of a worm wheel transmission, other direct transmissions, or for example a chain, rope or belt transmission are also applicable.

The transmission element 9 has a recess for removably including the driven axis 6 of the brushing unit 5, so that, by removing a fastening element, such as a locking pin, the brushing unit 5 can quickly be inserted into and/or quickly be removed from the recess of the transmission element 9.

The frame 3 is provided with ventilation apertures 10, formed by slotted apertures in the exemplary embodiment shown, although any other shape is also applicable, for removing the heat generated by the driving motor 7 from the hollow, internal space 4 of the frame 3. If desired, there can be provided a cooling fan or a fluid cooling.

A wall of the frame 3 is provided with a connector element 11 for connecting thereto a feeder cable, comprising two feeder cable portions 13a, 13b, for connection with an external supply source. The feeder cable portions 13a, 13b are interconnected by means of a connecting element 14, which is fastened on the mounting unit 1. The driving motor 7 is electrically connected with the connector element 11 via a line 12, the line 12 being completely located in the hollow, internal space 4 of the frame 3. Although an electric motor is used in the exemplary embodiment described, the present invention is also applicable while using a pneumatic or hydraulic motor.

A control circuit 15 for controlling the driving motor 7 is included in a housing in the hollow, internal space 4 of the frame 3. The driving motor 7, which is preferably suitable for rotating the drive shaft 8 in two opposite directions of rotation, is controlled by a switch mechanism of the control circuit 15 in such a way that the drive shaft 8 is alternately rotated in opposite directions. This reversal of the direction of rotation can be controlled by a timer circuit located in the control circuit 15. The direction of rotation can also be reversed after each brushing run. It is pointed out here that, as described in U.S. Pat. No. 6,318,298 B1, a brushing run is activated by activating a switch that is operatively connected with the driving motor 7 to activate the driving motor 7 when pressure is exerted on the brushing unit 5 by a cow. The switch mechanism can also have an alarm function: there is switched a potential-free contact if a temperature protection is switched on or in case of failure of the power supply.

Thus, the invention has been described by reference to certain embodiments discussed above. It will be recognized that these embodiments are susceptible to various modifications and alternative forms well known to those of skill in the art, without departing from the spirit and scope of the invention. Accordingly, although specific embodiments have been described, these are examples only and are not limiting upon the scope of the invention.

What is claimed is:

1. A device for brushing animals, the device comprising:
a mounting unit for mounting the device to a stationary construction element;
a pivot element connected with the mounting unit;
a frame connected with the pivot element and being pivotable about the pivot element, the frame comprising a hollow internal space;
a brushing unit fastened on the frame and comprising a driven axis, which extends into the hollow internal space of the frame;
a driving motor with a drive shaft for driving the brushing unit, the driving motor being disposed in the hollow internal space of the frame; and
a transmission element disposed between the drive shaft of the driving motor and the driven axis of the brushing unit for transmitting rotation from the drive shaft to the driven axis, the transmission element being disposed in the hollow internal space of the frame.

2. The device for brushing animals as claimed in claim 1, wherein the frame is elongate having opposite ends and wherein the brushing unit is fastened near a first end of the frame and the driving motor is disposed near the first end of the frame in the hollow internal space.

3. The device for brushing animals as claimed in claim 1, wherein the transmission element has a recess for removably receiving the driven axis of the brushing unit.

4. The device for brushing animals as claimed in claim 1, wherein the transmission element is a worm wheel transmission.

5. The device for brushing animals as claimed in claim 1, wherein the frame is provided with ventilation apertures.

6. The device for brushing animals as claimed in claim 1, wherein a wall of the frame is provided with a connector element for connecting thereto a feeder cable for connection with an external supply source.

7. The device for brushing animals as claimed in claim 6, wherein the feeder cable comprises two feeder cable portions, which are interconnected by means of a connecting element, which is fastened on the mounting unit.

8. The device for brushing animals as claimed in claim 6, wherein the driving motor is electrically connected with the connector element via a line, the line being completely located in the hollow, internal space of the frame.

9. The device for brushing animals as claimed in claim 1, wherein the driving motor is suitable for rotating the drive shaft in two opposite directions of rotation, and in that the device is provided with a switch mechanism for alternately rotating the drive shaft in the opposite directions of rotation.

10. A device for brushing animals, the device comprising:
an elongate frame being pivotable about a pivot point, the frame comprising first and second ends and having a hollow internal space;
a brushing unit supported on the frame and comprising a driven axis extending into the hollow internal space of the frame;
a driving motor with a drive shaft for driving the brushing unit, the driving motor being generally disposed within the hollow internal space of the frame; and
a transmission element disposed between the drive shaft of the driving motor and the driven axis of the brushing unit for transmitting rotation from the drive shaft to the driven axis, the transmission element being disposed in the hollow internal space of the frame.

11. The device for brushing animals as claimed in claim 10, wherein the brushing unit is fastened near a first end of the frame and the driving motor is also disposed near the first end of the frame in the hollow internal space.

12. The device for brushing animals as claimed in claim 11, wherein the transmission element has a recess for removably receiving the driven axis of the brushing unit.

13. The device for brushing animals as claimed in claim 12, wherein the transmission element is a worm wheel transmission.

14. The device for brushing animals as claimed in claim 13, wherein the frame is generally enclosed and provided with ventilation apertures.

15. The device for brushing animals as claimed in claim 14, wherein a wall of the frame is provided with a connector element for connecting thereto a feeder cable for connection with an external energy supply source.

16. The device for brushing animals as claimed in claim 15, wherein the feeder cable comprises two feeder cable portions, which are interconnected by means of a connecting element, located exterior to the frame.

17. The device for brushing animals as claimed in claim 16, wherein the driving motor is electrically connected with the connector element via a line, the line being completely located in the hollow, internal space of the frame.

18. The device for brushing animals as claimed in claim 17, wherein the driving motor rotates the drive shaft in two opposite directions of rotation, and in that the device is provided with a switch mechanism for alternately rotating the drive shaft in the opposite directions of rotation.

19. The device for brushing animals as claimed in claim 18, further comprising a mounting unit for mounting the device to a stationary construction and a pivot element connecting the frame with the mounting unit.

20. The device for brushing animals as claimed in claim 19, wherein the pivot element is connected adjacent the second end of the frame.
